(19) United States
(12) Patent Application Publication
(10) Pub. No.: US 2022/0108226 A1
(43) Pub. Date: Apr. 7, 2022

(54) VOTING-BASED APPROACH FOR DIFFERENTIALLY PRIVATE FEDERATED LEARNING

(71) Applicant: NEC Laboratories America, Inc., Princeton, NJ (US)

(72) Inventors: Xiang Yu, Mountain View, CA (US); Yi-Hsuan Tsai, Santa Clara, CA (US); Francesco Pittaluga, Los Angeles, CA (US); Masoud Faraki, San Jose, CA (US); Manmohan Chandraker, Santa Clara, CA (US); Yuqing Zhu, Mountain View, CA (US)

(21) Appl. No.: 17/491,663

(22) Filed: Oct. 1, 2021

Related U.S. Application Data
(60) Provisional application No. 63/086,245, filed on Oct. 1, 2020.

(51) Int. Cl. G06N 20/20; G06N 5/02; G06N 5/04

(52) U.S. Cl. CPC G06N 20/20; G06N 5/04; G06N 5/027

(57) ABSTRACT

A method for employing a general label space voting-based differentially private federated learning (DPFL) framework is presented. The method includes labeling a first subset of unlabeled data from a first global server, to generate first pseudo-labeled data, by employing a first voting-based DPFL computation where each agent trains a local agent model by using private local data associated with the agent, labeling a second subset of unlabeled data from a second global server, to generate second pseudo-labeled data, by employing a second voting-based DPFL computation where each agent maintains a data-independent feature extractor, and training a global model by using the first and second pseudo-labeled data to provide provable differential privacy (DP) guarantees for both instance-level and agent-level privacy regimes.

### RELATED APPLICATION INFORMATION

This application claims priority to Provisional Application No. 63/086,245, filed on Oct. 1, 2020, the contents of which are incorporated herein by reference in their entirety.

### BACKGROUND

### Technical Field

The present invention relates to federated learning (FL) and, more particularly, to a voting-based approach for differentially private federated learning (DPFL).

### Description of the Related Art

Differentially Private Federated Learning (DPFL) is an emerging field with many applications. Gradient averaging based DPFL methods require costly communication rounds and hardly work with large capacity models due to explicit dimension dependence in its added noise.

### SUMMARY

A method for employing a general label space voting-based differentially private federated learning (DPFL) framework is presented. The method includes labeling a first subset of unlabeled data from a first global server, to generate first pseudo-labeled data, by employing a first voting-based DPFL computation where each agent trains a local agent model by using private local data associated with the agent, labeling a second subset of unlabeled data from a second global server, to generate second pseudo-labeled data, by employing a second voting-based DPFL computation where each agent maintains a data-independent feature extractor, and training a global model by using the first and second pseudo-labeled data to provide provable differential privacy (DP) guarantees for both instance-level and agent-level privacy regimes.

A non-transitory computer-readable storage medium comprising a computer-readable program for employing a general label space voting-based differentially private federated learning (DPFL) framework is presented. The computer-readable program when executed on a computer causes the computer to perform the steps of labeling a first subset of unlabeled data from a first global server, to generate first pseudo-labeled data, by employing a first voting-based DPFL computation where each agent trains a local agent model by using private local data associated with the agent, labeling a second subset of unlabeled data from a second global server, to generate second pseudo-labeled data, by employing a second voting-based DPFL computation where each agent maintains a data-independent feature extractor, and training a global model by using the first and second pseudo-labeled data to provide provable differential privacy (DP) guarantees for both instance-level and agent-level privacy regimes.

A system for employing a general label space voting-based differentially private federated learning (DPFL) framework is presented. The system includes a memory and one or more processors in communication with the memory configured to label a first subset of unlabeled data from a first global server, to generate first pseudo-labeled data, by employing a first voting-based DPFL computation where each agent trains a local agent model by using private local data associated with the agent, label a second subset of unlabeled data from a second global server, to generate second pseudo-labeled data, by employing a second voting-based DPFL computation where each agent maintains a data-independent feature extractor, and train a global model by using the first and second pseudo-labeled data to provide provable differential privacy (DP) guarantees for both instance-level and agent-level privacy regimes.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of an exemplary general label space voting-based differentially private federated learning (DPFL) framework, in accordance with embodiments of the present invention;

FIG. 2 is a block/flow diagram of an exemplary process flow of the general label space voting-based DPFL framework, in accordance with embodiments of the present invention;

FIG. 3 is a block/flow diagram of an exemplary aggregation ensemble DPFL (AE-DPFL) architecture and a k Nearest Neighbor DPFL (kNN-DPFL) architecture, in accordance with embodiments of the present invention;

FIG. 4 is an exemplary practical application for employing a general label space voting-based DPFL framework, in accordance with embodiments of the present invention;

FIG. 5 is an exemplary processing system for employing a general label space voting-based DPFL framework, in accordance with embodiments of the present invention; and

FIG. 6 is a block/flow diagram of an exemplary method for employing a general label space voting-based DPFL framework, in accordance with embodiments of the present invention.

### DETAILED DESCRIPTION OF PREFERRED EMBODIMENTS

Federated learning (FL) is an emerging paradigm of distributed machine learning with a wide range of applications. FL allows distributed agents to collaboratively train a centralized machine learning model without sharing each of their local data, thereby sidestepping the ethical and legal concerns that arise in collecting private user data for the purpose of building machine-learning based products and services.

The workflow of FL is often enhanced by secure multi-party computation (MPC) so as to handle various threat models in the communication protocols, which provably ensures that agents can receive the output of the computation (e.g., the sum of the gradients) but nothing in between (e.g., other agents' gradients).

However, MPC alone does not protect the agents or their users from inference attacks that use only the output or combine the output with auxiliary information. Extensive studies demonstrate that these attacks may lead to a blatant reconstruction of proprietary datasets, high-confidence identification of individuals (a legal liability for the participating agents), or even completion of social security numbers. Motivated by these challenges, there have been a number of recent efforts in developing federated learning methods with differential privacy (DP), which is a well-established definition of privacy that provably prevents such attacks.

Existing methods in differentially private federated learning (DPFL), e.g., DP-FedAvg and DP-FedSGD, are predominantly noisy gradient based methods, which build upon the NoisySGD method, a classical algorithm in (non-federated) DP learning. They work by iteratively aggregating (multi-)gradient updates from individual agents using a differentially private mechanism. A notable limitation is that such approaches require clipping the l₂ magnitude of gradients to a threshold S and adding noise proportional to S to every coordinate of the high dimensional parameters from the shared global model. The clipping and perturbation steps introduce either large bias (when S is small) or large variance (when S is large), which interferes with convergence of SGD, which makes scaling to large-capacity models difficult. The exemplary methods illustrate that FedAvg may fail to decrease the loss function using gradient clipping, and DP-FedAvg requires many outer loop iterations (e.g., many rounds of communication to synchronize model parameters) to converge under differential privacy.

In view thereof, the exemplary embodiments introduce a fundamentally different DP learning setting known as a Knowledge Transfer model (also referred to as the Model-Agnostic Private learning model). This model requires an unlabeled dataset to be available in the clear, which makes this setting slightly more restrictive. However, when such a public dataset is indeed available (it often is in federated learning with domain adaptation), it could substantially improve the privacy-utility tradeoff in DP learning.

The goal is to develop DPFL algorithms under the knowledge transfer model, for which two algorithms or computations (AE-DPFL and kNN-DPFL) are introduced, that further develop from the non-distributed Private-Aggregation-of-Teacher-Ensembles (PATE) and Private-kNN to the FL setting. The exemplary methods discover that the distinctive characteristics of these algorithms make them natural and highly desirable for DPFL tasks. Specifically, the private aggregation is now essentially privately releasing “ballot counts” in the (one-hot) label space, instead of the parameter (gradient) space. This naturally avoids the aforementioned issues associated with high dimensionality and gradient clipping. Instead of transmitting the gradient update, transmitting the vote of the “ballot counts” reduces the communication cost. Moreover, many iterations of the model update using noise addition with SGD, leads to poor privacy guarantee, where the exemplary methods avoid this situation and use voting on labels, thus significantly outperforming the conventional DPFL methods.

The contributions are summarized as follows:

The exemplary methods construct examples to demonstrate that DPFedAvg may fail due to gradient clipping and requires many rounds of communications, while the exemplary approach naturally avoids both limitations.

The exemplary methods design two voting-based distributed algorithms or computations that provide provable DP guarantees on both agent-level and instance (of-each-agent)-level granularity, which makes them suitable for both well-studied regimes of FL, that is, distributed learning from on-device data and collaboration of a few large organizations.

The exemplary methods demonstrate “privacy-amplification by ArgMax” by a new MPC technique, where the proposed private voting mechanism enjoys an exponentially stronger (data-dependent) privacy guarantee when the “winner” wins by a large margin.

Extensive evaluation demonstrates that the exemplary methods systematically improve the privacy utility trade-off over DP-FedAvg and DP-FedSGD, and that the exemplary methods are more robust towards distribution-shifts across agents.

Though AE-DPFL and kNN-DPFL are algorithmically similar to the original PATE and Private-KNN, they are not the same as they are applied to a new area, that is, federated learning. The facilitation itself is nontrivial and requires substantial technical innovations.

The exemplary methods highlight the challenges below:

To begin with, several key DP techniques that contribute to the success of PATE and Private-kNN in the standard settings are no longer applicable (e.g., privacy amplification by sampling and noisy screening). This is partially because in standard private learning, the attacker only sees the final models, however in FL, the attacker can eavesdrop in all network traffic and could be a subset of the agents themselves.

Moreover, PATE and Private-kNN only provide instance-level DP. Instead, AE-DPFL and kNN-DPFL also satisfy the stronger agent-level DP. AE-DPFL's agent-level DP parameter is, interestingly, a factor of two better than its instance-level DP parameter. kNN-DPFL in addition enjoys a factor of k amplification for the instance-level DP.

Finally, a challenge of FL is data heterogeneity of individual agents. Methods like PATE randomly split the dataset so each teacher is identically distributed, but this assumption is violated with heterogeneous agents. Similarly, methods like Private-kNN have also been demonstrated only under homogeneous settings. In contrast, the exemplary methods (AE-DPFL and kNN-DPFL) exhibit robustness to data heterogeneity and domain shifts.

The exemplary methods start by introducing the notations of federated learning and differential privacy. Then, by introducing the two different level DP definitions, two randomized gradient-based baselines, DP-FedAvg and DP-FedSGD, are introduced as DPFL background.

To start off, regarding federated learning, the exemplary methods consider N agents, each agent i has nᵢ data kept local and private from a party-specific domain distribution [symbol] ᵢ∈X×Y, where X denotes the feature space and Y={0, . . . , C−1} denotes the label.

Regarding the problem setting, the goal is to train a privacy preserving global model that performs well on the server distribution [symbol] _{G} without centralizing local agent data. The exemplary embodiments assume access to an unlabeled dataset containing independent and identically distributed (I.I.D) samples from the server distribution [symbol] _{G}. This is a standard assumption from “agnostic federated learning” literature, and more flexible than fixing [symbol] _{G} to be the uniform user distribution over the union of all agents. The choice of [symbol] _{G} is application-specific and it represents the various considerations of the learning objective such as accuracy, fairness and the need for personalization. The setting is closely related to the multisource domain adaptation problem but is more challenging due to restricted access to source (local) data.

Regarding FL baseline, FedAvg is a vanilla federated learning algorithm without DP guarantees. A fraction of agents is sampled at each communication round with a probability q. Each selected agent downloads the shared global model and is fine-tuned with local data for E iterations using stochastic gradient descent (SGD). This local update process is denoted as an inner loop. Then, only the gradients are sent to the server, and averaged across all the selected agents to improve the global model. The global model is learned after T communication rounds. Each communication round is denoted as one outer loop.

Regarding differential privacy for federated learning, differential privacy is a quantifiable definition of privacy that provides provable guarantees against identification of individuals in a private dataset.

A first definition, for differential privacy, is given as: a randomized mechanism [symbol] : [symbol] → [symbol] with a domain [symbol] and range [symbol] satisfies (ϵ, δ)-differential privacy, if for any two adjacent datasets D, D′∈ [symbol] and for any subset of outputs [symbol] ⊆ [symbol] , it holds that Pr[ [symbol] (D)∈ [symbol] ]≤e^{∈}Pr[ [symbol] (D′)∈ [symbol] ]+δ.

The definition indicates that a person cannot distinguish between D and D′, and therefore the “delta” between D, D′ is protected. Depending on how adjacency is defined, this “delta” comes with different semantic meaning. The exemplary methods consider two levels of granularity:

A second definition, for agent-level DP, is given as: when D′ is constructed by adding or removing an agent from D (with all data points from that agent).

A third definition, for instance-level DP, is given as: when D′ is constructed by adding or removing one data point from any of the agents.

The above two definitions are each important in particular situations. For example, when a smart phone app jointly learns from its users' text messages, it is more appropriate to protect each user as a unit, which is agent-level DP. In another situation, when a few hospitals would like to collaborate on a patient study through federated learning, obfuscating the entire dataset from one hospital is meaningless, which makes instance-level DP better-suited to protect an individual patient from being identified.

Regarding DPFL baselines, DP-FedAvg (Algorithm 1 reproduced below), a representative DPFL algorithm, when compared to FedAvg, DP-FedAvg enforces clipping of per-agent model gradient to a threshold S (Step 3 in Algorithm 1; NoisyUpdate) and adds noise to the scaled gradient before it is averaged at the server, which ensures agent-level DP. DP-FedSGD, focuses on instance-level DP. DP-FedSGD performs NoisySGD for a fixed number of iterations at each agent. The gradient updates are averaged on each communication round at the server.

Algorithm 1 DP-FedAvg

```
Input: Agent selection probability q, noise scale σ,
clipping threshold S.
  1: Initialize global model θ⁰
  2: for t = 0, 1, 2, . . . , T do
  3:  mₜ ← Sample agents with q
  4:  for each agent i in parallel do
  5:  Δᵢ^{t} = NoisyUpdate (i, θ^{t}, t, σ, mₜ)
  $\text{6:} {θ}^{t + 1} = {θ}^{t} + \frac{1}{{m}_{t}} {Σ}_{i = 0}^{{m}_{1}} {△}_{i}^{t}$
  NoisyUpdate (i, θ⁰, t, σ, mₜ)
  1: θ ← θ⁰
  2: θ ← E iterations SGD from θ⁰
  $\text{3:} {△}_{i}^{t} = ( θ - {θ}^{0} ) \text{/} max ( 1 , \frac{{‖ θ - {θ}^{0} ‖}_{2}}{S} )$
  4: return update Δᵢ^{t} + [symbol] (0, σ²S²/mₜ)
```

Regarding multi-party computation (MPC), MPC is a cryptographic technique that securely aggregates local updates before the server receives it. While MPC does not have a differential privacy guarantee, it can be combined with DP to amplify the privacy guarantee. Specifically, if each party adds a small independent noise to the part they contribute, MPC ensures that an attacker can only observe the total, even if the attacker taps the network messages and hacks into the server. The exemplary methods consider a new MPC technique that allows only the voted winner to be released while keeping the voting scores completely hidden. This allows the exemplary methods to further amplify the DP guarantees.

Regarding knowledge transfer models in differential privacy, PATE and Private-kNN are two knowledge transfer models for model-agnostic private training. They assume a private labeled dataset Dprivate and an unlabeled public dataset [symbol] _{G}. The goal is to label a sequence of unlabeled public data by leveraging an ensemble of teacher models trained on the disjoint partition of the private dataset (see PATE) or leveraging the private release of k-nearest neighbor (see Private kNN).

Noisy screening and subsampling (Algorithm 2 reproduced below) are two fundamental techniques that improve the privacy-utility trade-offs of PATE and Private-kNN. The subsampling process amplifies the privacy guarantee in Private-kNN. The noisy screening step adds a larger scale of Gaussian noise (σ₀>σ₁ in Algorithm 2) and then releases a more confident noisy prediction if the query passes screening. However, they are no longer applicable in the DPFL setting due to the more threat adversary models and the new DP setting (agent-level and instance-level DP). For example, subsampling each client's local data does not imply a straightforward amplified instance-level DP, and noisy screening can double the communication cost.

Algorithm 2 Private-kNN Algorithm [41]. Privacy am-
plification by sampling and noisy screening (highlighted
in blue) are not applicable in the DPFL setting.

Input: Private dataset [symbol] ₚᵣᵢᵥₐₜₑ unlabeled public data [symbol]
_{G}, number of query Q, noisy screening parameter σ₀,
noisy aggregation parameter σ₁, feature map ϕ and the
screening threshold T [symbol] ,

| | |
|---|---|
| 1: | for t = 0, 1, ..., Q, pick xₜ ϵ [symbol] _{G} do |
| 2: | [symbol] _{γ}, ← a random subset from Dₚᵣᵢᵥₐₜₑ using sam- |
| | pling with the sampling ratio γ. |
| 3: | Apply ϕ on D_{γ} and xₜ. |
| 4: | y₁, ..., yₖ ← labels of the k nearest neighbor |
| 5: | Noisy Screening: f̅ᵢ(xₜ) = Σᵢ₌₁^{k} fᵢ(xₜ) + |
| | [symbol] (0, σ₀²I_{C}). |
| 6: | if f̅ᵢ(xₜ) ≥ T [symbol] : |
| 7: | y̅ₜ = argmax_{yϵ{1,...,c}} Σᵢ₌₁^{k} fᵢ(xₜ) + [symbol] (0,σ₁²I_{C}) |
| 8: | else: Skip the current query xₜ. |
| 9: | end for |

output A public model θ trained using (xₜ, y̅ₜ)ₜ₌₁^{Q}. [symbol]
indicates data missing or illegible when filed

Before introducing the exemplary approaches, the motivation behind them is highlighted by exposing the challenges in the conventional DPFL methods in terms of gradient estimation, convergence, and data heterogeneity.

The first challenge relates to biased gradient estimation. Recent works have shown that the FedAvg may not converge well under data heterogeneity. An example is presented to show that the clipping step of DPFedAvg may exacerbate the issue.

Let N=2, each agent i's local update is Δᵢ (E iterations of SGD). Clipping of per-agent update Δᵢ are enforced by performing

$${Δ}_{i} \text{/} max ( 1 , \frac{{‖ {Δ}_{i} ‖}_{2}}{S} ) ,$$

where S is the clipping threshold. Consider the special case when ∥Δ₁∥₂=S+α and ∥Δ₂∥₂≤S. Then the global update will be

$$\frac{1}{2} ( \frac{S {Δ}_{1}}{{‖ {Δ}_{1} ‖}_{2}} + {Δ}_{2} ) ,$$

which is biased.

Comparing to the FedAvg updates ½ (Δ₁+Δ₂), the biased update could be 0 (not moving) or pointing towards the opposite direction. Such a simple example can be embedded in more realistic problems, causing substantial bias that leads to non-convergence.

The second challenge relates to slow convergence. Following works on FL convergence analysis, the convergence analysis on DP-FedAvg is derived and it is demonstrated that using many outer-loop iterations (T) could result in similar convergence issue under differential privacy.

The appeal of FedAvg is to set E to be larger so that each agent performs E iterations to update its own parameters before synchronizing the parameters to the global model, hence reducing the number of rounds in communication. It is shown that the effect of increasing E is essentially increasing the learning rate for a large family of optimization problems with piece-wise linear objective functions, which does not change the convergence rate. Specifically, it is known that for the family of G-Lipschitz functions supported on a B-bounded domain, any Krylov-space method has a convergence rate that is lower bounded by Ω(BG/√T). This indicates that the variant of FedAvg requires Ω(1/α²) rounds of outer loop (communication) in order to converge to an a stationary point, that is, increasing E does not help, even if no noise is added.

It also indicates that DP-FedAvg is essentially the same as the stochastic sub-gradient method in almost all locations of a piece-wise linear objective function with gradient noise being N(0, σ²/N I_{d}). The additional noise in DP-FedAvg imposes more challenges to the convergence. If T rounds are run and (∈, δ)-DP is to be achieved, then:

$$σ = \frac{η EG \sqrt{2 T log ( 1.25 \text{/} δ )}}{N ϵ}$$

Which results in a convergence rate upper bound of:

$$\frac{GB ( \sqrt{1 + \frac{2 Td log ( 1.25 \text{/} δ )}{{N}^{2} {ϵ}^{2}}} )}{\sqrt{T}} = O ( \frac{GB}{\sqrt{T}} + \frac{\sqrt{d log ( 1.25 \text{/} δ )}}{N ϵ} )$$

for an optimal choice of the learning rate Eη.

The above bound is tight for stochastic sub-gradient methods, and also for information-theoretically optimal. The GB/√T part of upper bound matches the information-theoretical lower bound for all methods that have access to T-calls of stochastic sub-gradient oracle. While the second matches the information-theoretical lower bound for all (∈, δ)-differentially private methods on the agent level. That is, the first term indicates that there must be many rounds of communications, while the second term indicates that the dependence in ambient dimension d is unavoidable for DP-FedAvg. The exemplary method also has such dependence in the worst case. But it is easier for the exemplary approach to adapt to the structure that exists in the data (e.g., high consensus among voting). In contrast, it has larger impact on DP-FedAvg, since it needs to explicitly add noise with variance Ω(d). Another observation is when N is small, no DP method with reasonable ∈, δ parameters can achieve high accuracy for agent-level DP.

The third challenge relates to data heterogeneity. FL with domain adaptation has been studied, where a dynamic attention model is proposed to adjust the contribution from each source (agent) collaboratively. However, most multi-source domain adaptation algorithms require sharing local feature vectors to the target domain, which is not compatible with the DP setting. Enhancing DP-FedAvg with the effective domain adaptation technique remains an open problem.

To alleviate the above challenges, the exemplary embodiments propose two voting-based algorithms or computations, “AE-DPFL” and “kNN-DPFL”. Each algorithm first privately labels a subset of data from the server and then trains a global model using pseudo-labeled data.

In AE-DPFL (Algorithm 3 reproduced below), each agent i trains a local agent model fi using its own private local data. The local model is not revealed to the server but only used to make predictions for unlabeled data (queries). For each query xₜ, every agent i adds Gaussian Noise to the prediction (e.g., C-dimensional histogram where each bin is zero except the fi(xₜ)-th bin is 1). The “pseudo label” is achieved with the majority vote returned by aggregating the noisy predictions from the local agents.

Algorithm 3 AE-DPFL with MPC-Vote

```
input Noise level σ, unlabeled public data [symbol] _{G},
  integer Q.
  1: Train local model fᵢ ming [symbol] i or using ( [symbol] ᵢ, [symbol]  _{G})
    with any domain adaptation techniques.
  2: for t = 0, 1, . . . , Q, pick xₜ ∈ [symbol] _{G} do
  3:  for each agent i in 1, . . . , N (in parallel) do
  $\text{4:} {{f}^{–}}_{i} ( {x}_{t} ) = {f}_{i} ( {x}_{t} ) + 𝒩 ( 0 , \frac{{σ}^{2}}{N} {I}_{C} ) .$
  5:  end for
  6:  y̅ₜ = argmax_{y∈{1,...,C}}[Σᵢ₌ₘ^{N} f̅ᵢ(xₜ)]_{y} via MPC.
  7: end for
output A global model θ trained using (xₜ, y̅ₜ)ₜ₌₁^{Q}
```

For instance-level DP, the spirit of the exemplary method shares with PATE, in the aspect of by adding or removing one instance, it can change at most one agent's prediction. The same argument also naturally applies to adding or removing one agent. In fact, the exemplary methods gain a factor of two in the stronger agent-level DP due to a smaller sensitivity in the exemplary approach.

Another important difference is that in the original PATE, the teacher models are trained on I.I.D data (random splits of the whole private data), while in the current exemplary case, the agents are naturally present with different distributions. The exemplary methods propose to optionally use domain adaptation techniques to mitigate these differences when training the agents.

From the second and third definitions, preserving agent-level DP is generally more difficult than the instance-level DP. It is found that for AE-DPFL, the privacy guarantee for instance-level DP is weaker than its agent-level DP guarantee. To amplify the instance-level DP, kNN-DPFL is introduced.

In Algorithm 4, reproduced below, each agent maintains a data-independent feature extractor φ, i.e., an ImageNet pre-trained network without the classifier layer. For each unlabeled query xₜ, agent i first finds the ki nearest neighbors to xₜ from its local data by measuring the Euclidean distance in the feature space [symbol] ^{d}^{_{φ}}. Then, fi(xₜ) outputs the frequency vector of the votes from the nearest neighbors, which equals to

$$\frac{1}{k} ( {\sum }_{j = 1}^{k} {y}_{j} ) ,$$

where yⱼ∈ [symbol] ^{C} indicates the one-hot vector of the groundtruth label. Subsequently, fi(xₜ) from all agents are privately aggregated with the argmax of the noisy voting scores returned to the server.

Algorithm 4 kNN-DPFL with MPC-Vote

```
input Noise level σ, unlabeled public data [symbol] _{G},
  integer Q, feature map ϕ.
  1: for t = 0, 1, . . . , Q, pick xₜ ∈ [symbol] _{G} do
  2:  for each agent i in 1, . . . , N (in parallel) do
  3:  Apply ϕ on [symbol] ᵢ and xₜ
  4:  y₁, . . . , yₖ ← labels of the k nearest neighbor.
  $\text{5:} {{f}^{–}}_{i} ( {x}_{t} ) = \frac{1}{k} ( {Σ}_{j = 1}^{k} {y}_{j} ) + 𝒩 ( 0 , \frac{{σ}^{2}}{N} {I}_{C} )$
  6:  end for
  7:  y̅ₜ = argmax_{y∈{1,...,C}}[Σᵢ₌ₘ^{N} f̅ᵢ(xₜ)]_{y} via MPC.
  8: end for
output A global model θ trained using (xₜ, y̅ₜ)ₜ₌₁^{Q}
```

Besides the highlighted differences from Algorithm 2, the kNN-DPFL differs from Private-kNN in that the exemplary embodiments apply kNN on each agent's local data instead of the entire private dataset. This distinction together with MPC allows the exemplary methods to receive up to kN neighbors while bounding the contribution of individual agents by k. Compared to AE-DPFL, this approach enjoys a stronger instance-level DP guarantee since the sensitivity from adding or removing one instance is a factor of k/2 times smaller than that of the agent-level.

Regarding privacy analysis, the privacy analysis is based on Renyi differential privacy (RDP).

Regarding definition 5 for Renyi Differential Privacy (RDP), a randomized algorithm [symbol] is (α, ∈(α))-RDP with order α≥1 if for neighboring datasets D, D′,

$${𝔻}_{α} ( ℳ ( D ) \vert \vert ℳ ( {D}^{′} ) ) \text{:=} \frac{1}{α - 1} log {𝔼}_{o ∼ ℳ ( {D}^{′} )} [ {( \frac{Pr [ ℳ ( D ) = o ]}{Pr [ ℳ ( {D}^{′} ) = o ]} )}^{α} ] \leq ϵ ( α ) .$$

RDP inherits and generalizes the information theoretical properties of DP and has been used for privacy analysis in DP-FedAvg and DP-FedSGD. Notably RDP composes naturally and implies the standard (∈, δ)-DP for all δ>0.

Regarding lemma 6, composition property of RDP, if [symbol] obeys [symbol] (⋅)-RDP, then:

∈₍ [symbol] _{₁} [symbol] _{₂₎}(·)=∈ [symbol] _{₁}(·)+∈ [symbol] _{₂}(·).

This composition rule often allows for tighter calculations of (∈, δ)-DP for the composed mechanism than the strong composition theorem. Moreover, RDP can be converted to (∈, δ)-DP for any δ>0 using:

Regarding lemma 7, from RDP to DP, if a randomized algorithm [symbol] satisfies (α, ∈(α))-RDP, then [symbol] also satisfies

$$( ϵ ( α ) + \frac{log ( 1 \text{/} δ )}{α - 1} , δ ) \text{-} DP$$

for any δ∈(0, 1).

Regarding theorem 8, privacy guarantee, let AE-DPFL and kNN-DPFL answer Q queries with noise scale σ. For agent-level protection, both algorithms guarantee

$$( α , \frac{Q α}{2 {σ}^{2}} ) \text{-} RDP$$

for all α≥1. For instance-level protection, AE-DPFL and kNN-DPFL obey

$$( α , \frac{Q α}{{σ}^{2}} ) and ( α , \frac{Q α}{k {σ}^{2}} ) \text{-} RDP$$

respectively.

The proof is as follows: in AE-DPFL, for query x, by the independence of the noise added, the noisy sum is identically distributed to Σᵢ₌₁^{N}fᵢ(x)+ [symbol] (0, σ²).

Adding or removing one data instance from will change Σᵢ₌₁^{N}fi(x) by at most √2 in L2. This is because fi(x) can change from class a to class b, which may change the a-th and the b-th bin simultaneously in the sum. The Gaussian mechanism thus satisfies (α, αs²/2σ²)-RDP on the instance level for all α≥1 with an L2-sensitivity s=√2.

For the agent-level, the L2 and L1 sensitivities are both 1 for adding or removing one agent. This is because adding or removing one agent can only add or remove the fi(x)-th bin in the sum by one.

In kNN-DPFL, the noisy sum is identically distributed to:

$$\frac{1}{k} {\sum }_{i = 1}^{N} {\sum }_{j = 1}^{k} {y}_{i , j} + 𝒩 ( 0 , {σ}^{2} )$$

The change of adding or removing one agent will change the sum by at most 1, which implies the same L2 sensitivity and same agent-level protection as AE-DPFL. The L2-sensitivity from adding or removing one instance, on the other hand, changes the score by at most \sqrt{2/k} in L2 due to that the instance being replaced by another instance, this leads to an improved instance-level DP that reduces ∈ by a factor of

$$\sqrt{\frac{k}{2}} .$$

The overall RDP guarantee follows the composition over Q queries. The approximate-DP guarantee follows the standard RDP to DP conversion formula

$$ϵ ( α ) + \frac{log ( 1 \text{/} δ )}{α - 1}$$

and optimally choosing α.

Theorem 8 suggests that both algorithms achieve agent-level and instance-level differential privacy. With the same noise injection to the agent's output, kNN-DPFL enjoys a stronger instance level DP (by a factor of k/2) compared to its agent-level guarantee, while AE-DPFL's instance-level DP is weaker by a factor of 2. Since AE-DPFL allows an easy-extension with the domain adaptation technique, the exemplary methods choose to use AE-DPFL for the agent-level DP and apply kNN-DPFL for the instance-level DP in the experiments.

Also, there is improved accuracy and privacy with large margin:

Let f₁, . . . , f_{N}: X→Δ^{C-1} where Δ^{C-1} denotes the probability simplex, that is, the soft-label space. Note that both exemplary algorithms can be viewed as voting of these local agents, which output a probability distribution in Δ^{C-1}. First, the margin parameter y(x) that measures the difference between the largest and second largest coordinate is defined as:

$$\frac{1}{N} {\sum }_{i = 1}^{N} {f}_{i} ( x ) .$$

Regarding lemma 9, conditioning on the local agents, for each server data point x, the noise added to each coordinate of

$$\frac{1}{N} {\sum }_{i = 1}^{N} {f}_{i} ( x )$$

is drawn from N(0, σ²/N²), then with probability≥1−C exp{−N²γ(x)²/8σ²}, the privately released label matches the majority vote without noise.

The proof is a straightforward application of Gaussian tail bounds and a union bound over C coordinates. This lemma implies that for all public data points x such that

$$γ ( x ) \geq \frac{2 \sqrt{2 log ( C \text{/} δ )}}{N} ,$$

the output label matches the noiseless majority votes with probability at least 1−δ.

Next, the exemplary methods illustrate that for those data point x such that γ(x) is large, the privacy loss for releasing

$${{argmax}_{j} [ \frac{1}{N} {\sum }_{i = 1}^{N} {f}_{i} ( x ) ]}_{j}$$

is exponentially smaller. The result is based on the following privacy amplification lemma.

Regarding lemma 10, let [symbol] satisfy (2α, ∈)-RDP. Then, there is a singleton output that happens with probability 1-q when [symbol] is applied to D. As a result, for any D′ that is adjacent to D, Renyi-divergence is given as:

$${D}_{α} ( ℳ ( D ) \vert \vert ℳ ( {D}^{′} ) ) \leq - log ( 1 - q ) + \frac{1}{α - 1} log ( 1 + {{q}^{1 \text{/} 2} ( 1 - q )}^{α - 1} {e}^{( α - 1 ) ϵ} ) .$$

The proof is given as follows: let P, Q be the distribution of [symbol] (D) and [symbol] (D′), respectively, and E be the event that the singleton output is selected.

$$\begin{matrix}{𝔼}_{Q} [ {( dP \text{/} dQ )}^{α} ] = & {𝔼}_{Q} [ {( dP \text{/} dQ )}^{α} [ E ] {ℙ}_{Q} [ E ] + {𝔼}_{Q} [ {( dP \text{/} dQ )}^{α} 1 ( {E}^{c} ) \leq \\ & ( 1 - q ) {( \frac{1}{1 - q} )}^{α} + \sqrt{{𝔼}_{Q} [ ( dP \text{/} dQ ) ( 2 α ) ]} \sqrt{{𝔼}_{Q} [ 1 {( {E}^{c} )}^{2} ]} \leq \\ & {( 1 - q )}^{- ( α - 1 )} + {q}^{1 \text{/} 2} {e}^{( 2 α - 1 ) c \text{/} 2} \\ = & {( 1 - q )}^{- ( α - 1 )} ( 1 + {( 1 - q )}^{α - 1} {q}^{1 \text{/} 2} {e}^{\frac{2 α - 1}{2} c} )\end{matrix}$$

The first part of the second line uses the fact that event E is a singleton with probability larger than 1-q under Q and the probability is always smaller than 1 under P. The second part of the second line follows from CauchySchwartz inequality. The third line substitutes the definition of (2α, ∈)-RDP. Finally, the stated result follows by the definition of the Renyi divergence.

Regarding theorem 11, for each public data point x, the mechanism that releases

$${argmax}_{j} [ \frac{1}{N} {\sum }_{i = 1}^{N} {f}_{i} ( x ) + {N ( 0 , ( {σ}^{2} \text{/} {N}^{2} ) {I}_{C} ]}_{j} obeys ( α , ϵ ) \text{-} data \text{-} dependent \text{-} RDP ,$$

where

$$ϵ \leq 2 {Ce}^{- \frac{{N}^{2} {γ ( x )}^{2}}{8 {α}^{2}}} + \frac{1}{α - 1} log ( 1 + {e}^{\frac{( 2 α - 1 ) α x}{2 {σ}^{2}} - \frac{{N}^{2} {γ ( x )}^{2}}{8 {α}^{2}} + log C \text{/} 2} )$$

where s=1 for AE-DPFL with the agent-level DP, and s=2/k for KNN-DPFL with the instance-level DP.

The proof involves substituting

$$q = {Ce}^{- \frac{{N}^{2} {γ ( x )}^{2}}{8 {α}^{2}}}$$

from lemma 9 into lemma 10 and use the fact that [symbol] satisfies the RDP of a Gaussian mechanism from the RDP's post-processing lemma. The expression bound is simplified for readability using −log(1−x)<2x for all x>−0.5 and that (1−q)^{α-1}≤1.

This bound implies when the margin of voting scores is large, the agents enjoy exponentially stronger RDP guarantees in both agent-level and instance-level. In other words, the exemplary methods avoid the explicit dependence on model dimension d (unlike DP-FedAvg) and could benefit from “easy data” whenever there are high consensus among votes from local agents.

Theorem 11 is possible because the MPC-vote ensures that all parties (local agents, server and attackers) observe only the argmax but not the noisy-voting scores themselves. Finally, each agent works independently without any synchronization. Overall, the exemplary methods reduce the (per-agent) up-stream communication cost from d·T floats (model size times T rounds) to C·Q, where C is number of classes and Q is the number of data points.

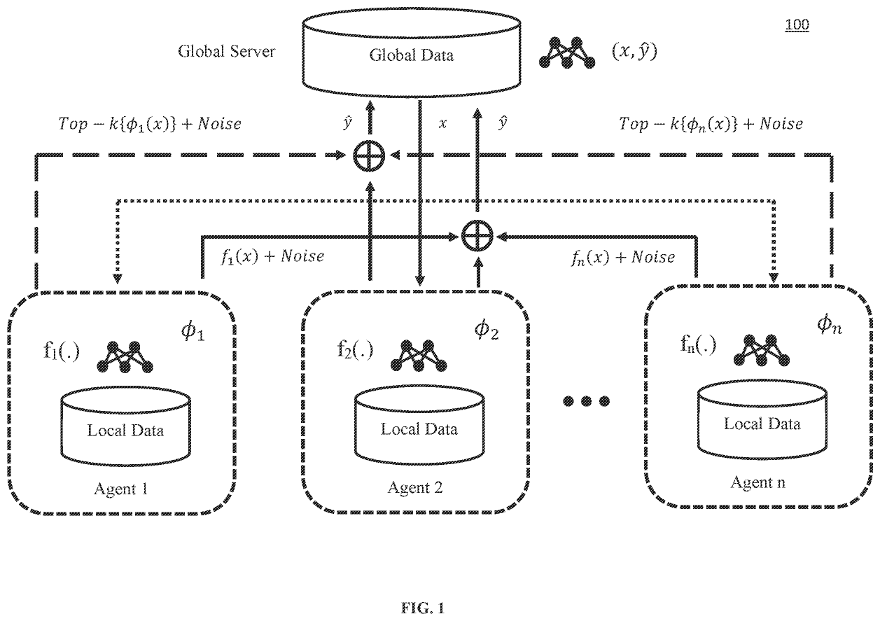

Regarding FIG. 1, architecture 100, a number of local agents each with its own local data is used to train each local model if the framework is PATE-FL, or all the local agents share the global model if the framework is Private-kNN-FL. Two pipelines are presented to deal with different situations, that is, when the number of agents is limited, the exemplary methods run the Private-kNN-FL, and when the number of agents are sufficient, the exemplary methods run the PATE-FL. Global server unlabeled data are fed to each of the local agents for the pseudo-labeling. Global server model training leverages the global data and the pseudo labels feedback from the label aggregation of all the agents.

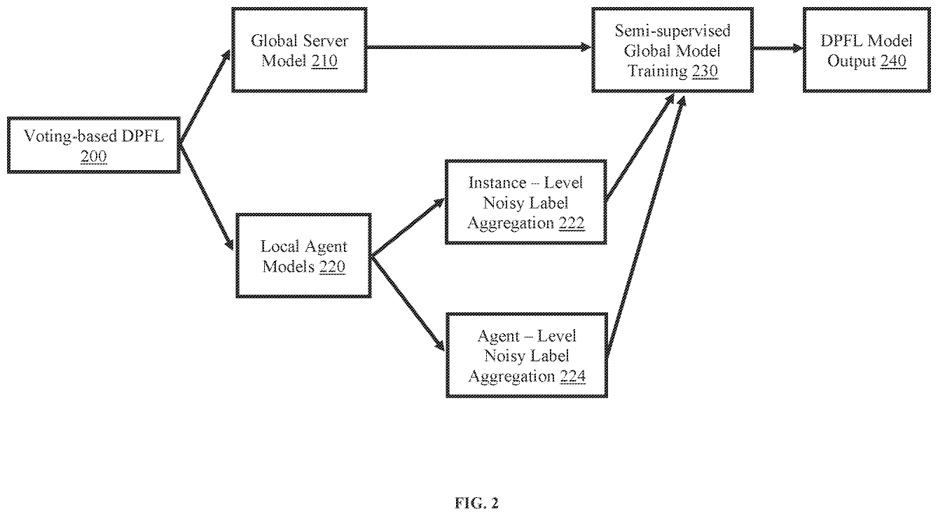

Regarding FIG. 2, the voting-based DPFL 200 includes a global server model 210 and local agent models 220. The local agent models 220 include an instance-level 222 and an agent-level 224. The semi-supervised global model training 230 results in the DPFL model output 240.

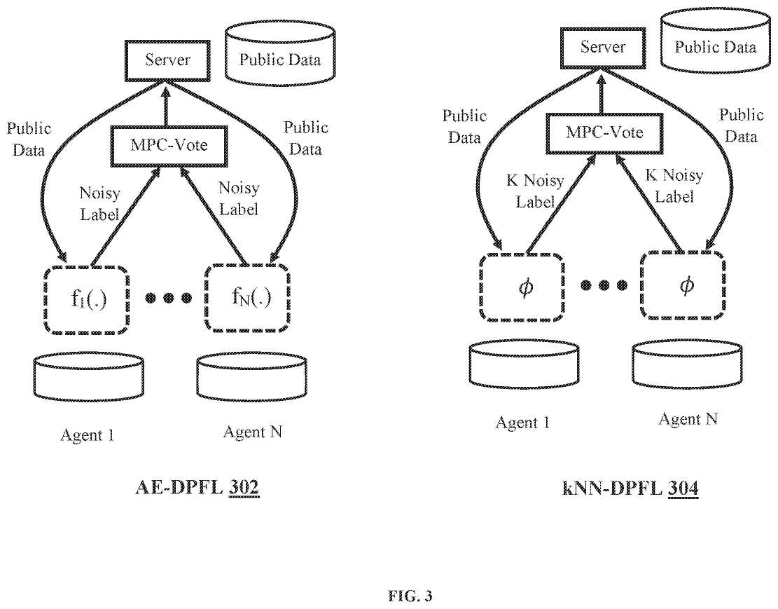

Regarding FIG. 3, the AE-DPFL 302 and the kNN-DPFL 304 architectures are shown.

In summary, the exemplary embodiments of the present invention focus on a federated learning framework that can protect privacy, which is achieved by applying a differential privacy technique to provide the theoretical and provable guarantee for privacy preservation. Traditional federated learning frameworks cannot protect privacy. This is because, the local data has been completely fed into the training of the global model, which injects the private information into the global model training. The exemplary embodiments introduce a general label space voting-based differentially private FL framework under two notions, that is, agent-level differential privacy and instance-level differential privacy, regarding large or limited amount of agents. To that extent, the exemplary methods introduce two DPFL algorithms or computations (AE-DPFL and kNN-DPFL) that provide provable DP guarantees for both instance-level and agent-level privacy regimes. By voting among the data labels returned from each local model, instead of averaging the gradients, the exemplary algorithms or computations avoid the dimension dependence and significantly reduce the communication cost. Theoretically, by applying secure multi-party computation, the exemplary embodiments could exponentially amplify the (data-dependent) privacy guarantees when the margin of the voting scores are distinctive.

Instead of traditional gradient aggregation, the exemplary embodiments propose to aggregate over the label space, which largely reduces not only the sensitivity issue introduced by the gradient clipping, but also the communication cost in federated learning. The exemplary embodiments provide a practical DPFL solution that improves the privacy-utility trade-off over the conventional DPFL gradient-based approach.

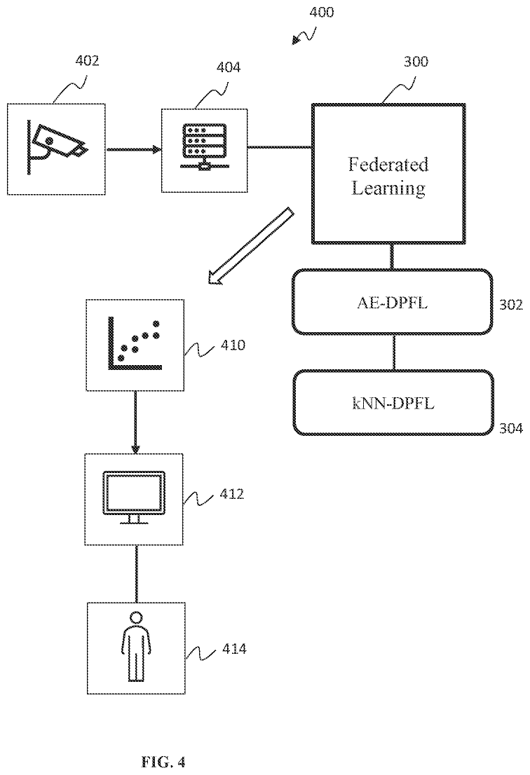

FIG. 4 is a block/flow diagram 400 of a practical application for employing a general label space voting-based differentially private federated learning (DPFL) framework, in accordance with embodiments of the present invention.

In one practical example, one or more cameras 402 can collect data 404 to be processed. The exemplary methods employ federated learning techniques 300 including AE-DPFL 302 and kNN-DPFL 304. The results 410 can be provided or displayed on a user interface 412 handled by a user 414.

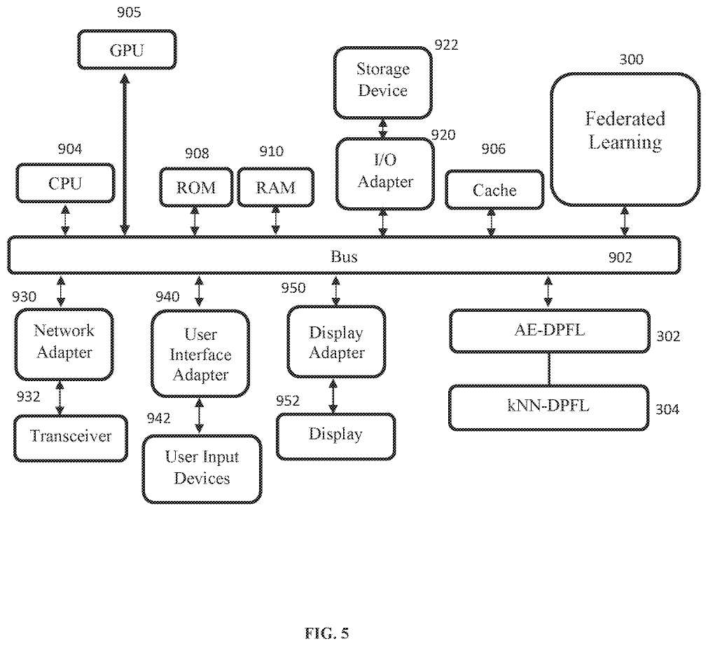

FIG. 5 is an exemplary processing system for employing a general label space voting-based differentially private federated learning (DPFL) framework, in accordance with embodiments of the present invention.

The processing system includes at least one processor (CPU) 904 operatively coupled to other components via a system bus 902. A GPU 905, a cache 906, a Read Only Memory (ROM) 908, a Random Access Memory (RAM) 910, an input/output (I/O) adapter 920, a network adapter 930, a user interface adapter 940, and a display adapter 950, are operatively coupled to the system bus 902. Additionally, the exemplary embodiments employ federated learning techniques 300 including AE-DPFL 302 and kNN-DPFL 304.

A storage device 922 is operatively coupled to system bus 902 by the I/O adapter 920. The storage device 922 can be any of a disk storage device (e.g., a magnetic or optical disk storage device), a solid-state magnetic device, and so forth.

A transceiver 932 is operatively coupled to system bus 902 by network adapter 930.

User input devices 942 are operatively coupled to system bus 902 by user interface adapter 940. The user input devices 942 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 942 can be the same type of user input device or different types of user input devices. The user input devices 942 are used to input and output information to and from the processing system.

A display device 952 is operatively coupled to system bus 902 by display adapter 950.

Of course, the processing system may also include other elements (not shown), as readily contemplated by one of skill in the art, as well as omit certain elements. For example, various other input devices and/or output devices can be included in the system, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system are readily contemplated by one of ordinary skill in the art given the teachings of the present invention provided herein.

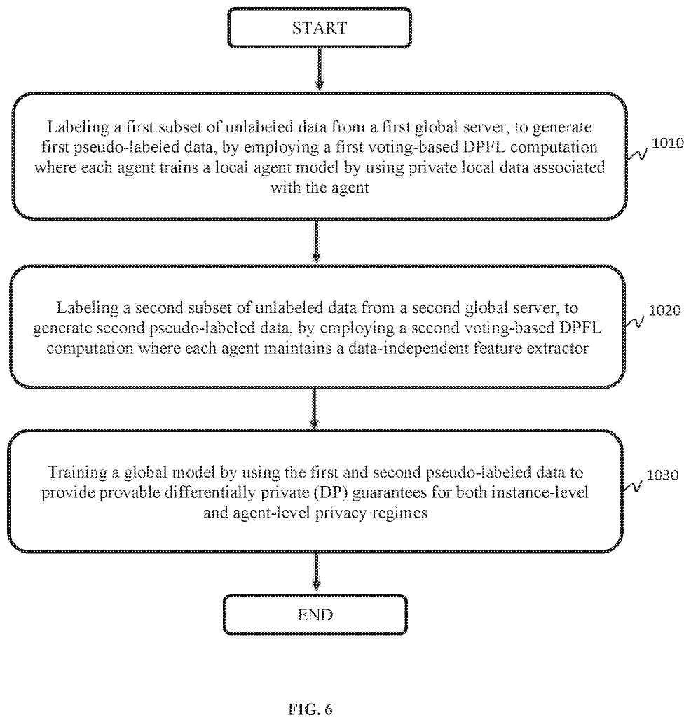

FIG. 6 is a block/flow diagram of an exemplary method for employing a general label space voting-based differentially private federated learning (DPFL) framework, in accordance with embodiments of the present invention.

At block 1010, label a first subset of unlabeled data from a first global server, to generate first pseudo-labeled data, by employing a first voting-based DPFL computation where each agent trains a local agent model by using private local data associated with the agent.

At block 1020, label a second subset of unlabeled data from a second global server, to generate second pseudo-labeled data, by employing a second voting-based DPFL computation where each agent maintains a data-independent feature extractor.

At block 1030, train a global model by using the first and second pseudo-labeled data to provide provable differentially private (DP) guarantees for both instance-level and agent-level privacy regimes.

As used herein, the terms “data,” “content,” “information” and similar terms can be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, the data can be received directly from the another computing device or can be received indirectly via one or more intermediary computing devices, such as, for example, one or more servers, relays, routers, network access points, base stations, and/or the like. Similarly, where a computing device is described herein to send data to another computing device, the data can be sent directly to the another computing device or can be sent indirectly via one or more intermediary computing devices, such as, for example, one or more servers, relays, routers, network access points, base stations, and/or the like.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “calculator,” “device,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can include, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or modules.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks or modules.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks or modules.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for employing a general label space voting-based differentially private federated learning (DPFL) framework, the method comprising:
labeling a first subset of unlabeled data from a first global server, to generate first pseudo-labeled data, by employing a first voting-based DPFL computation where each agent trains a local agent model by using private local data associated with the agent;
labeling a second subset of unlabeled data from a second global server, to generate second pseudo-labeled data, by employing a second voting-based DPFL computation where each agent maintains a data-independent feature extractor; and
training a global model by using the first and second pseudo-labeled data to provide provable differential privacy (DP) guarantees for both instance-level and agent-level privacy regimes.

2. The method of claim 1, wherein the first voting-based DPFL computation is an aggregation ensemble DPFL (AE-DPFL) and the second voting-based DPFL computation is a k nearest neighbor DPFL (kNN-DPFL).

3. The method of claim 1, wherein each agent in the first voting-based DPFL computation adds Gaussian noise to a prediction for the first subset of unlabeled data.

4. The method of claim 3, wherein the first pseudo-labeled data are generated with a majority vote returned by aggregating noisy predictions from each agent in the first voting-based DPFL computation.

5. The method of claim 1, wherein each agent in the second voting-based DPFL computation finds a k-nearest neighbor to an unlabeled query by measuring a Euclidean distance in a feature space.

6. The method of claim 5, wherein a frequency vector of votes from the nearest neighbor is output.

7. The method of claim 1, wherein voting aggregation in the first and second voting-based DPFL computations is conducted by multi-party computation (MPC).

8. The method of claim 1, wherein voting aggregation in the first and second voting-based DPFL computations involves releasing ballot counts in a latent space instead of a parameter space.

9. A non-transitory computer-readable storage medium comprising a computer-readable program for employing a general label space voting-based differentially private federated learning (DPFL) framework, wherein the computer-readable program when executed on a computer causes the computer to perform the steps of:
labeling a first subset of unlabeled data from a first global server, to generate first pseudo-labeled data, by employing a first voting-based DPFL computation where each agent trains a local agent model by using private local data associated with the agent;
labeling a second subset of unlabeled data from a second global server, to generate second pseudo-labeled data, by employing a second voting-based DPFL computation where each agent maintains a data-independent feature extractor; and
training a global model by using the first and second pseudo-labeled data to provide provable differential privacy (DP) guarantees for both instance-level and agent-level privacy regimes.

10. The non-transitory computer-readable storage medium of claim 9, wherein the first voting-based DPFL computation is an aggregation ensemble DPFL (AE-DPFL) and the second voting-based DPFL computation is a k nearest neighbor DPFL (kNN-DPFL).

11. The non-transitory computer-readable storage medium of claim 9, wherein each agent in the first voting-based DPFL computation adds Gaussian noise to a prediction for the first subset of unlabeled data.

12. The non-transitory computer-readable storage medium of claim 11, wherein the first pseudo-labeled data are generated with a majority vote returned by aggregating noisy predictions from each agent in the first voting-based DPFL computation.

13. The non-transitory computer-readable storage medium of claim 9, wherein each agent in the second voting-based DPFL computation finds a k-nearest neighbor to an unlabeled query by measuring a Euclidean distance in a feature space.

14. The non-transitory computer-readable storage medium of claim 13, wherein a frequency vector of votes from the nearest neighbor is output.

15. The non-transitory computer-readable storage medium of claim 9, wherein voting aggregation in the first and second voting-based DPFL computations is conducted by multi-party computation (MPC).

16. The non-transitory computer-readable storage medium of claim 9, wherein voting aggregation in the first and second voting-based DPFL computations involves releasing ballot counts in a latent space instead of a parameter space.

17. A system for employing a general label space voting-based differentially private federated learning (DPFL) framework, the system comprising:
a memory; and
one or more processors in communication with the memory configured to:
label a first subset of unlabeled data from a first global server, to generate first pseudo-labeled data, by employing a first voting-based DPFL computation where each agent trains a local agent model by using private local data associated with the agent;
label a second subset of unlabeled data from a second global server, to generate second pseudo-labeled data, by employing a second voting-based DPFL computation where each agent maintains a data-independent feature extractor; and
train a global model by using the first and second pseudo-labeled data to provide provable differential privacy (DP) guarantees for both instance-level and agent-level privacy regimes.

18. The system of claim 17, wherein the first voting-based DPFL computation is an aggregation ensemble DPFL (AE-DPFL) and the second voting-based DPFL computation is a k nearest neighbor DPFL (kNN-DPFL).

19. The system of claim 17, wherein each agent in the first voting-based DPFL computation adds Gaussian noise to a prediction for the first subset of unlabeled data.

20. The system of claim 19,
wherein the first pseudo-labeled data are generated with a majority vote returned by aggregating noisy predictions from each agent in the first voting-based DPFL computation; and
wherein each agent in the second voting-based DPFL computation finds a k-nearest neighbor to an unlabeled query by measuring a Euclidean distance in a feature space.
